(19) United States
(12) Patent Application Publication
(10) Pub. No.: US 2010/0248810 A1
(43) Pub. Date: Sep. 30, 2010

(54) SYMBOL CROSS-OVER

(75) Inventors: Benny Sum, Las Vegas, NV (US); Michael Dreitzer, Las Vegas, NV (US)

Correspondence Address: Watson & Rounds, 5371 Kietzke Lane, Reno, NV, 89511, US

(73) Assignees: Benny Sum, Las Vegas, NV (US); Michael F. Dreitzer, Las Vegas, NV (US)

(21) Appl. No.: 12/708,503

(22) Filed: Feb. 18, 2010

Related U.S. Application Data
(60) Provisional application No. 61/153,819, filed on Feb. 19, 2009.

(51) Int. Cl. A63F 9/24; A63F 13/00

(52) U.S. Cl. 463/20; 463/30; 463/25

(57) ABSTRACT

A slot machine with game play crossing over between at least two sets of symbols each from a particular game theme. Game play on the slot machine displays on a set of reels a plurality of symbols of a first game theme. Play is initiated on the reels and the reels are stopped. A determination is made as to whether at least one symbol designated as a trigger symbol is located in a stop position designated as a trigger position. The game crosses over or switches to a second game theme with a plurality of second symbols on the set of reels if the trigger symbol is located in the trigger position. Game play may include, but not necessarily be limited to one or more of the following: simple cross over play between two games, free spins in a different theme, bonus games in a different theme, player selected trigger symbols, randomly selected trigger symbols, player selected game themes and player selection of the number of game themes to include in a play session.

### CROSS-REFERENCE TO RELATED APPLICATION

This application claims the benefit of provisional patent application Ser. No. 12/708,503, filed 18 Feb. 2010, by the present inventor, Benny Sum, which is incorporated herein by reference.

### STATEMENT OF COPYRIGHTED MATERIAL

A portion of the disclosure of this patent document contains material which is subject to copyright protection. The copyright owner has no objection to the facsimile reproduction by anyone of the patent document or the patent disclosure, as it appears in the PTO patent file or records, but otherwise reserves all copyright rights whatsoever.

### BACKGROUND OF THE INVENTION

Slot machines employ various techniques to maintain player interest and encourage continued game play. Two such techniques include the Free Spin and the Bonus Game features incorporated into a reel slots game played on a video console. A video slot machine of the type enabled to play both Free Spin and Bonus Games is illustrated in FIG. 1. This slot machine includes a video display screen having a representative depiction of five reels, with three symbols displayed per reel. This illustration is intended to represent any of the commonly available video slot machine games which are enabled for Bonus Game and/or Free Spin methods of play.

Each time a player presses a spin button (or pulls a spin lever), the symbols on the video display screen are changed according to the operating software of the game system. A Free Spin or Bonus Game is activated when one or more predefined symbols appear in a winning location or combination on the display screen. Depending upon the game, the bonus round may be a special session of Free Spins or a special Bonus Game.

In order to increase player interest and enjoyment, slot machines of the type shown in FIG. 1 are configured to maintain a particular game theme. For one simple example, a game theme may comprise a prehistoric/dinosaur theme in which artistic renderings of theme creatures and theme landscapes adorn not only the slot machine cabinet, but also form some or all of the symbols appearing on the reels. This theme is maintained throughout game play, and even carried forward into a Bonus Game if the operating software is so enabled.

A common symbol used to trigger a Bonus Game or Free Spins is known as a scatter symbol. If a scatter symbol appears anywhere on the slot's screen, it might activate the Bonus Game or the Free Spins opportunity. In some game methods, multiple scatters must appear on the reels to trigger bonus round play. When the game is configured in this manner, the scatters can be spread anywhere throughout the three to five reels in no particular order. When the predetermined number of scatters appears, the Bonus Game is triggered. In all cases, the scatter symbol (or other triggering symbol) maintains the theme associated with the particular game play. Thus, in the prehistoric/dinosaur example suggested above, the scatter or triggering symbol may be a volcano, or a Tyrannosaurus Rex, or some other indicia within the chosen theme.

Regular reel play is suspended temporarily while the player pursues the Free Spin or Bonus Game rounds. When the Bonus Game or Free Spins round comes to an end, game play reverts to the primary reel slots game.

There is a need in the gaming field to provide interesting new slot machines and games played on slot machines so as to capture the interest of new players and to maintain the interest of veteran players. Accordingly, any enhancements or improvements to prior art methods of slot machine play will be readily accepted.

### BRIEF DESCRIPTION OF THE DRAWINGS

FIG. 1 is a prior art video slot machine enabled to play both free spin and bonus games;

FIG. 2 is a video slot machine with enlarged depictions for free spin and bonus game screens for a particular game theme in accordance with the present invention;

FIG. 3 is a video slot machine with an enlarged depiction for a bonus game screen for a different game theme in accordance with the present invention;

FIG. 4 shows a trigger symbol on a particular game theme screen with a free spin screen of a second game theme matching the trigger symbol in accordance with the present invention; and

FIG. 5 shows a group of trigger symbols on a particular game theme screen with a bonus game screen of a second game theme matching the trigger symbol in accordance with the present invention.

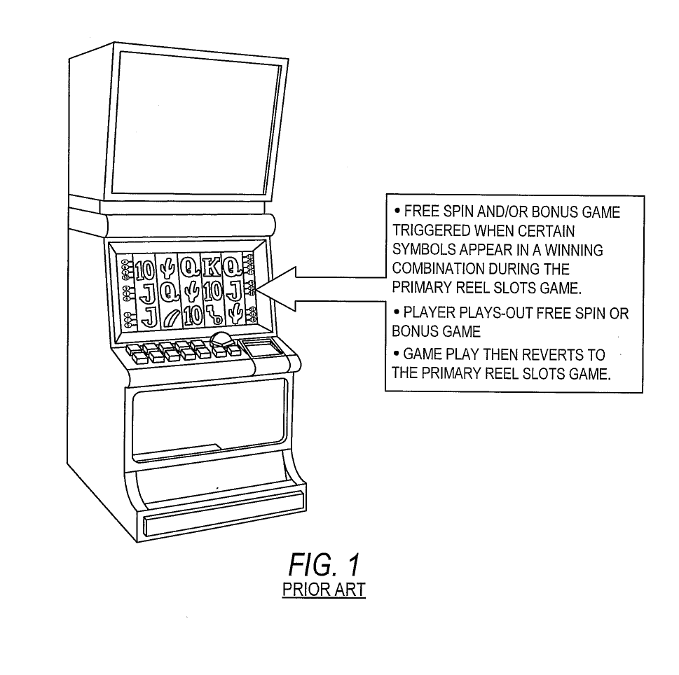

### SPECIFICATIONS

### DETAILED DESCRIPTION OF THE PREFERRED EMBODIMENT

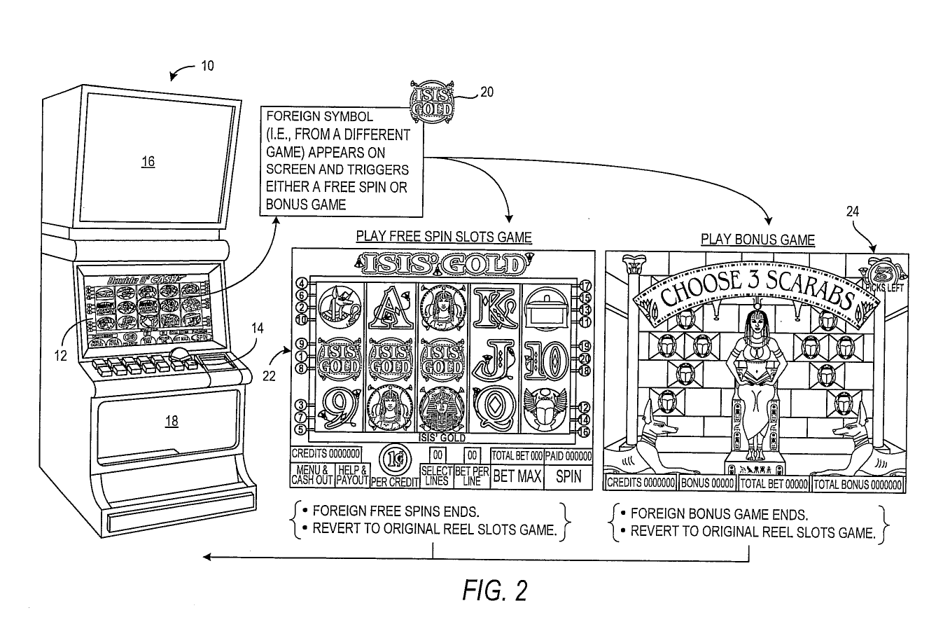

Referring to the FIGS. 2 through 5, a slot machine is generally shown at 10. The slot machine 10 can be any type or variety, but is here depicted as an upright model having a centrally located video display screen 12 set conveniently above an array of user interface buttons, at least one of which 14 activates a spin feature. The machine 10 may further include top glass 16 and belly glass 18 which may be artistically adorned with inviting images associated with the theme of a particular game being played through the video display screen 12. In the example shown in FIGS. 2 through 5, one exemplary reel slots game may be the “Double 0' Cash” game marketed by Global Gaming Group, Inc., assignee of the subject invention. It is to be understood that the “Double 0' Cash” game is proprietary to the assignee, and its use here is offered as an example only and not to be considered in any way public property or limiting of this invention. In other words, a standard reel slots game from any manufacturer can be played on the slot machine 10 in accordance with the fundamentals of this invention.

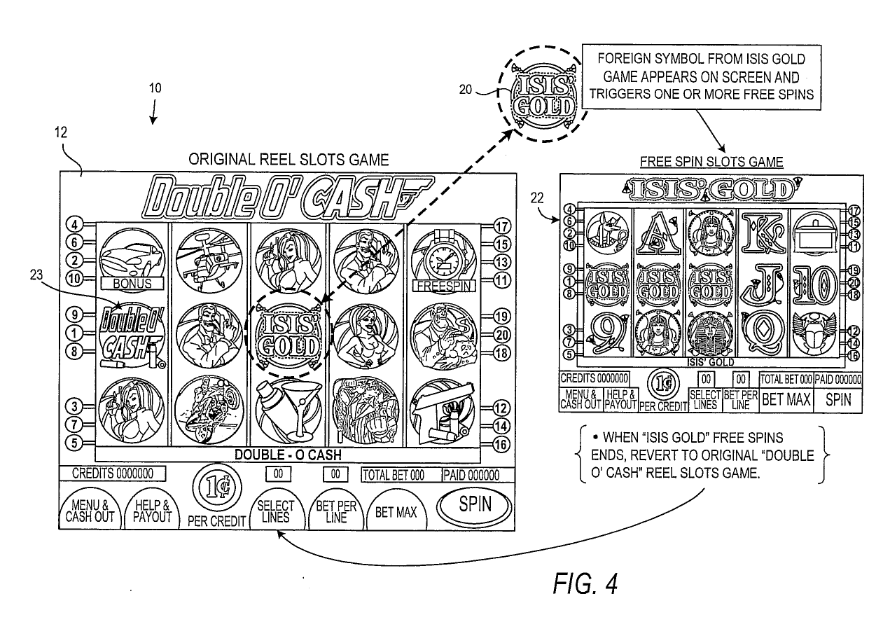

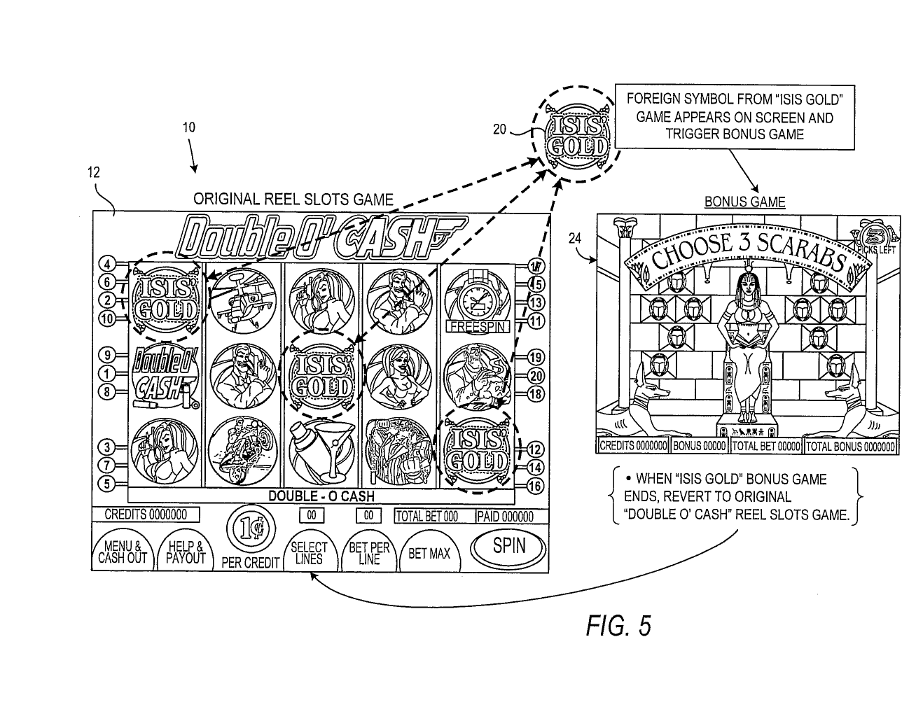

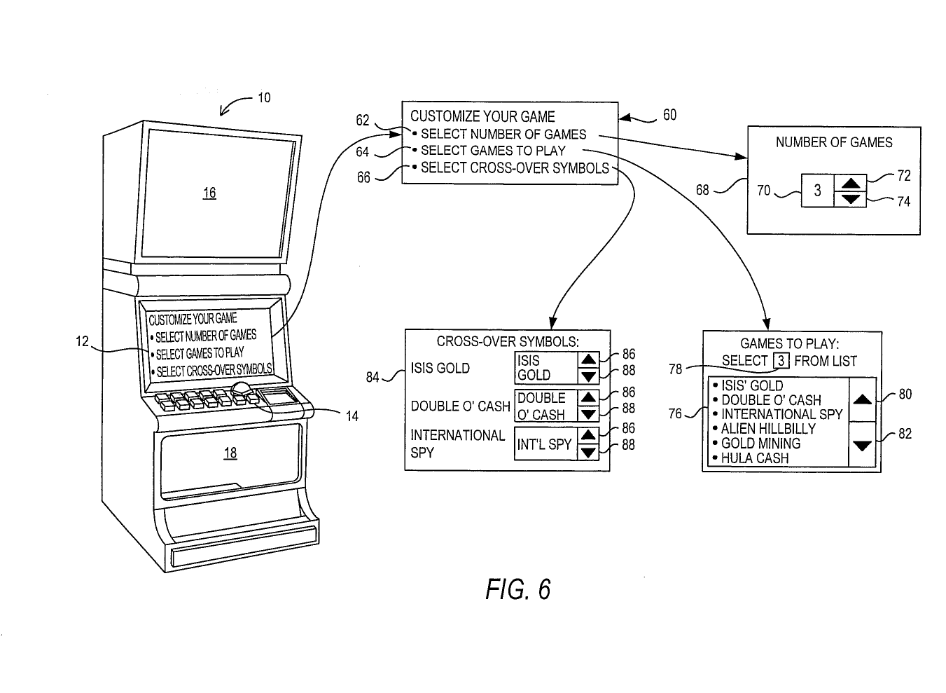

Continuing with the preceding example of a reel slots game, the video display screen 12 presents a number of columns representing reels, in this case five reels each displaying three symbols. As can perhaps best be seen from the enlarged views of the video display screen 12 in FIGS. 4 and 5, the game symbols all comprise images associated with a game theme—in this case the theme is of an international spy or secret agent.

The subject invention is distinguished from the prior art, however, in that the method of playing the original slots game include an opportunity to cross over or switch from one particular game theme to a second game theme during play. It is possible to implement the cross over or switching of games in any number of embodiments.

One embodiment uses one or more foreign trigger symbols 20 in the first game theme. A foreign symbol 20 is one which has no connection to the theme of the original game, and which in fact exists as a regular symbol in a completely different reel slots game. In this example, the foreign symbol 20 contains the words “Isis' Gold” and is associated with a proprietary reel slots game known as “Isis' Gold” marketed by the assignee of the present invention. Of course, the use of “Isis' Gold” is merely an example, and it will be understood any commercially available reel slots game can be substituted for “Isis' Gold” to accomplish the purposes of this invention. Thus “Isis' Gold” is used only for illustrative purposes.

The “Isis' Gold” game embodies an ancient Egyptian theme which is wholly distinct from that of the original reel slot game “Double 0' Cash.” According to this embodiment of the invention, when one or more foreign symbols 20 appears on the video display screen 12 during normal play of the original reel slots game, in a predetermined location or locations, either a Free Spin slots game 22 will be triggered or a Bonus Play game 24 will be triggered depending on the particular game rules. If the Free Spin game 22 is triggered by the appearance of one or more foreign trigger symbols 20 in the appropriate locations/combinations on the display screen 12, then the foreign game, in this case “Isis' Gold,” overtakes the video display screen 12 and the player plays out the Free Spins game wholly within the context of the foreign game. Thus, all of the Free Spin 22 play occurs through the alternative, foreign game “Isis' Gold.” Once the number of Free Spins ends, game play reverts to the original reel slots game, e.g., “Double 0' Cash.” Any winnings accumulated during the Free Spins portion is automatically transferred to the original reel slots game.

If the appearance of one or more foreign trigger symbols 20 on the display screen 12 triggers a Bonus Game, the foreign Bonus Game 24 overtakes the video display screen 12 and the player plays out the entire Bonus Game 24 within the context of the foreign game, in this case “Isis' Gold” Bonus Game 24. All winnings associated with the foreign Bonus Game 24 are credited to the original reel slots game. Once foreign Bonus Game play ends, game play reverts to the original reel slots game which, in the examples used throughout, comprises the “Double 0' Cash” game.

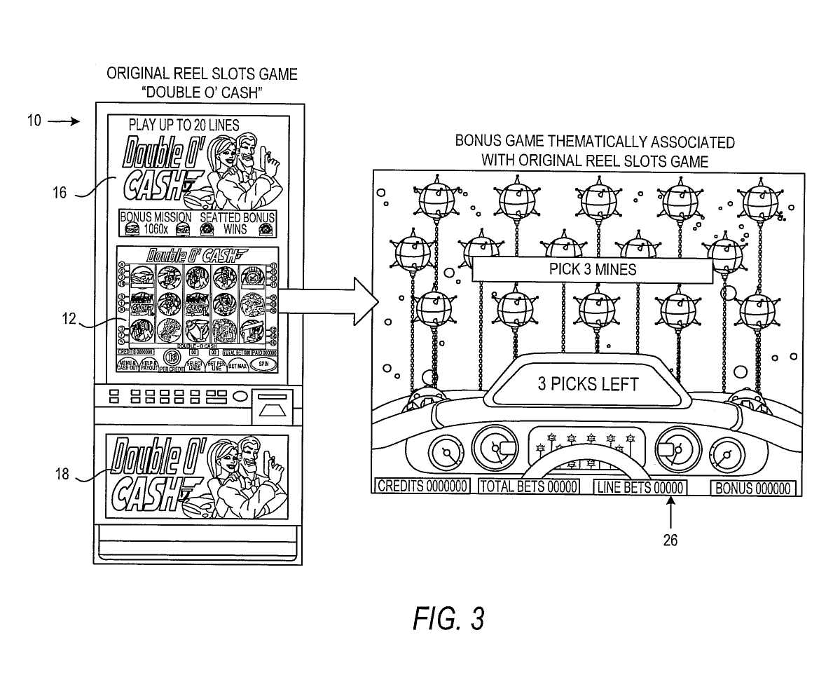

FIG. 3 is an enlarged view of a slot machine 10 according to the subject invention, wherein the original reel slots game is played on the video display screen 12, with artistic renderings supporting the international spy or secret agent theme. Artwork adorning the top glass 16 and the belly glass 18 reinforce the theme of the original reel slots game. Play of the original reel slots game continues fully within the theme of the original reel slots game, even when its bonus round 26 is triggered in the normal course. In other words, when the symbols associated with the original reel slots game trigger a Bonus Game according to the rules of the original reel slots game, the original Bonus Game 26 is played. Play on the original Bonus Game 26 ends in the normal course, and then game play reverts to the original reel slots game.

FIG. 4 includes an enlarged view of the video display screen 12 showing the appearance of a foreign symbol 20 on the center column reel. This foreign symbol 20 appears in a location that, according to a hypothetical game rule, is sufficient to trigger a Free Spins slot game 22. The Free Spins slot game 22 is again shown in the exemplary “Isis' Gold” theme, as described above. When the “Isis' Gold” Free Spins play ends, play reverts to the original “Double 0' Cash” reel slots game and any winnings are transferred back into the original game play.

FIG. 5 is a view as in FIG. 4, but depicting the appearance of multiple foreign symbols 20 on the display screen 12 in numbers and/or locations sufficient to trigger a Bonus Game 24. The Bonus Game 24 is here shown as that commonly associated with the “Isis' Gold” game, which is merely an example. The player plays out the Bonus Game 24 in the “Isis' Gold” game, with accumulated winnings being transferred directly to the original reel slots game. When the “Isis' Gold” Bonus Game 24 ends, game play reverts to the original “Double 0' Cash” reel slots game.

An alternative embodiment of the invention may switch between two game themes during the ordinary course of play. In this embodiment, a single trigger symbol or multiple trigger symbols that are foreign symbols 20 to the first game theme may trigger a change of games to a second game theme. For example, the first game theme may be “Double 0' Cash.” A player may play “Double 0' Cash” until a foreign trigger symbol 20 or more than one foreign trigger symbol appears in an appropriate location or combination on the display screen 12 causes a trigger event. When the trigger event occurs, the first game theme, “Double 0' Cash” is changed over to a second game theme, which may be “Isis' Gold,” as an example. The player may continue to play Isis' Gold until a similar trigger event caused by a trigger symbol from the Double 0' Cash game in Isis' Gold causes the game to switch back again to Double 0' Cash. This pattern continues indefinitely as the player hits different combinations of symbols during game play on display screen 12 of the two different games.

The present invention increases the player's level of entertainment and minimizes the opportunity for a player to become bored playing a single game. It should be understood that the invention is designed to introduce at least two game themes to a player's gaming session and may introduce a larger number of games during play on a single machine. Game play may be designed to switch between multiple games when trigger symbols 20 appear in the appropriate locations during play. It should also be understood that the trigger event need not be caused by a foreign symbol 20. The game may be designed such that a particular symbol or group of symbols from the particular game theme may cause a trigger event that switches the game to one of the other themes.

For example, in the Double 0' Cash game shown in FIG. 4, a single “Double 0' Cash” symbol 23 in the center position on the first reel may trigger a switch to a different game theme. Alternatively, more than one “Double 0' Cash” symbol 23 lined up in a particular combination may be required to trigger the switch to the different game theme. In this embodiment, the player may be pleasantly surprised when the game changes to a second game theme since s/he may not be tracking the winning combinations too closely and the cross over or switch in games occurs without warning.

Another feature that may be made available to a player operating a slot machine 10 with the present invention to enhance the gaming experience is to permit the player to customize play. Customizing play in the present invention may come in a number of different forms, including allowing the player to select the particular games that will be used in a particular session of games to be played. For example, the player may like “Double 0' Cash” and the International Spy games but perhaps does not enjoy “Isis' Gold.” That player may select “Double 0' Cash” and “International Spy” for the play session but not “Isis' Gold.” By offering the player a choice of games to play using the invention, the player will get an enhanced gaming experience and is likely to play slot machine 10 for a longer period of time. Selection of the particular games can be made by the player using buttons 14 after being offered game choices on a menu screen on display 12 before the start of any game.

The use of multiple games may also be used in combination with the bonus rounds and free spin opportunities described herein. For example, an implementation of the invention may include trigger events that permit changing games between “Double 0' Cash,” “Isis' Gold” and “International Spy.” Within each of these games, there may be opportunities for the player to earn free spins or be eligible for a bonus game. For any of the three base games, the free spins or bonus round may switch to a different game theme or may stay within the same game theme as the base game that was being played. Along with selecting the particular game themes to play, the player may also choose the number of game themes to be crossed over in a particular gaming session.

Other opportunities for a player to customize play in the accordance with the present invention may be related to the selection of a particular trigger symbol. For example, a player may be permitted to pick a favorite symbol from the “Isis' Gold” game to act as the trigger symbol to switch over to “Isis' Gold” from play in “Double 0' Cash.” Similarly, the player may select a favorite “Double 0' Cash” symbol to be used in “Isis' Gold” to switch over to “Double 0' Cash.” Or, it is possible to offer a player a selection of symbols from other existing games or themes that are unrelated to the games being in use on slot machine 10. For example, diamond symbols have been popular on slot machines for a long time. Various diamond symbols may be offered to a player as a customized trigger symbol whether to cross over to a different game, get free spins or enter a bonus game.

FIG. 6 shows slot machine 10 with display screen 12 and buttons 14. As an example of the process for customizing machine 10 by a player, the player may be presented with a menu such as that shown as “Customize Your Game” menu 60 that a player may see upon starting play. Customize menu 60 may also be called up at any time by the player using a touch screen button on display 12 or one of the dedicated buttons 14. Once at customizing menu 60, player may customize a number of the elements describe above. First, a player may highlight the “Select Number of Games” element 62 by either using dedicated buttons 14 or touch screen buttons appearing on display 12. Similarly, the player may highlight “Select Games to Play” element 64 or “Select Cross-Over Symbols” element 66. Once highlighted, each of elements, 62, 64, 66 take the player to a new screen displayed on display 12. In the case of “Select Number of Games,” 62, the player is presented with an opportunity to pick the number of games that they want to cross over between during play on screen 68. The default may be set to 2 games and is displayed in window 70, but the player can increase or decrease the number using touch scrolling arrows 72 and 74.

Once the number of games has been selected, the player may choose the particular games to be included during play at screen 76. The player is reminded of the number of games selected at screen 68 in window 78 (in this case −3). By scrolling up and down using touch scrolling arrows 80 and 82, the player can highlight the games that they want to play from the list. In FIG. 6, the list is shown with 5 games, but it could easily include a library of more games that are accessed by using touch scrolling buttons 80 and 82. In this case, the player has chosen “Isis' Gold,” “Double 0' Cash” and “International Spy” as can be seen in screen 84. Default games for each number of games selected may be set by the casino or the game designer.

Screen 84 is presented after the games are selected and may allow the player to choose the cross over symbol for each game. This may be accomplished using touch scrolling buttons 86 and 88 to scroll through a list of symbols for each of the selected games. As described above, the symbols may be those from the particular game, or symbols from another game either on the list or not on the list. The types of symbols are limited only by the imagination of the game designer and the number is unlimited but should probably be a reasonable number that allows the player to quickly view all of the possible selections. As with the number of games and the games selected, the cross-over symbols may have default settings for each game.

Once the game has been customized, the player may return to the customization menu at any time to change selections. Access to menu 60 or the sub-menus 68, 76 and 84 can be provided by the game designer. It should be understood that the menus shown are examples only and that there is an unlimited number of ways to offer the customization options to players.

The subject invention represents a novel improvement over slot machine gaming and play methods that will prevent slot machine game play from becoming mundane. As described above, when the player is in the midst of play in a game, a game theme crosses over or switches to a different game theme. This is accomplished upon the appearance of a certain trigger symbol 20 that may represent a different game being displayed. A Free Spin, a Bonus Round, or a different game theme begins which will automatically change all reel images to those associated with that different game theme. The trigger symbol 20 that appeared may be a foreign symbol from the different game that is displayed thereafter or it may be a symbol from an entirely different game theme. It also might be a random trigger symbol from the current game or a combination of any of the above.

Cross over happens for Free Spin opportunities, Bonus Games 24, or a change of games. The trigger symbol will appear and the player will play in a different game theme until a set of free spins or a bonus round ends, or until another trigger symbol appears causing the game to switch to another game theme.

The foregoing invention has been described in accordance with the relevant legal standards, thus the description is exemplary rather than limiting in nature. Variations and modifications to the disclosed embodiment may become apparent to those skilled in the art and fall within the scope of the invention.

What is claimed is:

1. An electronic gaming machine to be operated by a player comprising:
a housing; and
a display situated in the housing for displaying reels that are initiated by the player and that stop after a time interval, including:
a first set of symbols of a first game theme;
at least one trigger symbol; and
a stop position on the reels wherein if the at least one trigger symbol is located in the stop position when the reels stop, a second game theme is rendered for play on the display using a second set of symbols of the second game theme.

2. The electronic gaming machine of claim 1 wherein the rendering of the second game theme on the display gives the player a predetermined number of free spins of the second game theme.

3. The electronic gaming machine of claim 2 wherein the display returns to the first game theme upon completion of the free spins.

4. The electronic gaming machine of claim 2 further comprising a credit meter wherein any awards generated from the free spins are added to a player's credit count on the credit meter.

5. The electronic gaming machine of claim 1 wherein the rendering of the second game theme on the display is a bonus game that gives the player an opportunity to play the second game theme.

6. The electronic gaming machine of claim 5 wherein the display returns to the first game theme upon completion of the bonus game.

7. The electronic gaming machine of claim 5 further comprising a credit meter wherein any awards generated from the bonus game are added to a player's credit count on the credit meter.

8. The electronic gaming machine of claim 1 further comprising a selection switch operable by the player to select the bonus game from a plurality of second game themes available on the electronic gaming machine.

9. The electronic gaming machine of claim 1 wherein the rendering of the second game theme gives the player an opportunity to play the second game.

10. The electronic gaming machine of claim 9 wherein the display returns to the first game theme upon the appearance of at least one trigger symbol when the reels stop during play of the second game theme.

11. The electronic gaming machine of claim 10 further comprising a credit meter wherein any awards generated from play of the second game theme are added to a player's credit count on the credit meter.

12. The electronic gaming machine of claim 9 wherein the at least one trigger symbol is a foreign symbol that is not a symbol from the first game theme.

13. The electronic gaming machine of claim 1 further comprising a selection switch operable by the player to select the at least one trigger symbol from a plurality of trigger symbols available on the electronic gaming machine.

14. The electronic gaming machine of claim 1 further comprising a selection switch operable by the player to select at least one of the first and the second game themes from a plurality of game themes available to be played on the electronic gaming machine.

15. The electronic gaming machine of claim 1 further comprising the player selecting a number of game themes between which to be switched during a session of play.

16. A method of playing a game on an electronic gaming machine comprising:
displaying on at least one reel, symbols of a first game theme and at least one trigger symbol;
initiating play on the at least one reel;
stopping the at least one reel;
determining whether the at least one trigger symbol stopped in at least one particular stop position designated as at least one trigger position; and
displaying at least one reel with symbols of a second game theme if the at least one trigger symbol is located in the at least one trigger position.

17. The method of claim 16 further comprising awarding a number of free spins of the second game theme.

18. The method of claim 17 further comprising returning the at least one reel to the first game theme upon completion of the number of free spins.

19. The method of claim 17 further comprising adding any awards generated from the free spins to a player's credit count.

20. The method of claim 16 further comprising awarding a bonus game opportunity to the player wherein the bonus game is played using the second game theme.

21. The method of claim 20 further comprising returning to the first game theme upon completion of the bonus game.

22. The method of claim 20 further comprising adding any awards generated from the bonus game to a player's credit count.

23. The method of claim 16 further comprising the player selecting at least one of the first and the second game themes from a plurality of game themes available to be played on the electronic gaming machine.

24. The method of claim 16 further comprising returning to the first game theme upon the appearance of at least one second trigger symbol when the reels stop during play of the second game theme wherein the at least one second trigger symbol may be either the same as or different from the at least one trigger symbol.

25. The method of claim 16 wherein the at least one trigger symbol is a foreign symbol that is not a symbol from the first game theme.

26. The method of claim 16 further comprising the player selecting the at least one trigger symbol from a plurality of trigger symbols available on the electronic gaming machine.

27. The method of claim 16 further comprising the player selecting a number of game themes between which to be switched during a session of play.

28. A method of playing a game of chance comprising:
displaying on a set of reels comprising at least one reel, a plurality of symbols of a first game theme and at least one trigger symbol;
initiating play on the set of reels;
stopping the reels;
determining whether the at least one trigger symbol is located in at least one stop position designated as at least one trigger position; and
switching to a second game theme comprising a plurality of second symbols by displaying the second game theme on the set of reels if the at least one trigger symbol is located in the at least one trigger position.

29. The method of claim 28 further comprising a step of returning to the first game theme when at least one symbol designated as a second trigger symbol of the second game theme is located in at least one stop position designated as at least one second trigger position when the reels stop.

30. The method of claim 28 wherein one of either the at least one trigger symbol and at least one second trigger symbol is selected randomly for play of the first game theme or the second game theme respectively.

31. The method of claim 28 further comprising the player selecting at least one of the first and second game themes from a plurality of game themes available to be played.

32. The method of claim 28 further comprising awarding a number of free spins of the second game theme.

33. The method of claim 32 further comprising returning to the first game theme upon completion of the number of free spins.

34. The method of claim 32 further comprising adding any awards generated from the free spins to a player's credit count.

35. The method of claim 28 further comprising awarding a bonus game opportunity to the player wherein the bonus game is played using the second game theme.

36. The method of claim 35 further comprising returning to the first game theme upon completion of the bonus game.

37. The method of claim 35 further comprising adding any awards generated from the bonus game to a player's credit count.

38. The method of claim 28 further comprising the player selecting a number of game themes between which to be switched during a session of play.
